(19) United States
(12) Patent Application Publication
(10) Pub. No.: US 2010/0177712 A1
(43) Pub. Date: Jul. 15, 2010

(54) MULTICHANNEL/MULTIBAND OPERATION FOR WIRELESS DEVICE TO DEVICE COMMUNICATION

(75) Inventors: Jarkko KNECKT, Espoo (FI); Jakub MAJKOWSKI, Helsinki (FI)

Correspondence Address: MORGAN & FINNEGAN Transition Team;C/O Locke Lord Bissell & Liddell, 3 WORLD FINANCIAL CENTER, NEW YORK, NY, 10281-2101, US

(73) Assignee: NOKIA CORPORATION, Espoo (FI)

(21) Appl. No.: 12/354,168

(22) Filed: Jan. 15, 2009

(51) Int. Cl. H04W 74/00

(52) U.S. Cl. 370/329

(57) ABSTRACT

Method, apparatus, and computer program product embodiments are disclosed to improve the channel switching in communication protocols, by simplifying transmission of only a single, acknowledged switching message to trigger off channel—or base channel switching after an initial off channel configuration and set-up of the direct link. The single message off channel switching indication in direct link is based on two specific timeout timers that serve as a basis for channel switching between the devices in TDLS direct link. An immediate fallback transition is provided to the base channel in the event that the communication in the off-channel does not succeed. The timeouts in the fallback procedure allow continuing the planned data transfer immediately in the base channel of the TDLS direct link if the switching to the off channel has not succeeded.

### FIELD

The field of the invention relates to wireless communication and more particularly to direct link communication set-up for wireless local area network protocol.

### BACKGROUND

Modern society has quickly adopted, and become reliant upon, handheld devices for wireless communication. For example, cellular telephones continue to proliferate in the global marketplace due to technological improvements in both the communication quality and device functionality. These wireless communication devices have become common for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate wireless communication over large geographic areas. These network technologies have commonly been divided by generations, starting in the late 1970s to early 1980s with first generation (1G) analog cellular telephones that provided baseline voice communication, to modern digital cellular telephones. Global System for Mobile Communications (GSM) is an example of a widely employed 2G digital cellular network communicating in the 900 MHz/1.8 GHz bands in Europe and at 850 MHz and 1.9 GHz in the United States. This network provides voice communication and also supports the transmission of textual data via the Short Messaging Service (SMS). SMS allows a wireless communications device (WCD) to transmit and receive text messages of up to 160 characters, while providing data transfer to packet networks, Integrated Services Digital Network (ISDN) and Plain Old Telephone Service (POTS) users at 9.6 Kbps. The Multimedia Messaging Service (MMS), an enhanced messaging system allowing for the transmission of sound, graphics and video files in addition to simple text, has also become available in certain devices. Soon, emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced Data Rate (EDR) technology, which is also available, may enable maximum asymmetric data rates of 1448 Kbps for a 2 Mbps connection and 2178 Kbps for a 3 Mbps connection. In addition to Bluetooth™, other popular short-range wireless networks include for example IEEE 802.11 Wireless LAN, Wireless Universal Serial Bus (WUSB), Ultra Wideband (UWB), ZigBee (IEEE 802.15.4 and IEEE 802.15.4a), wherein each of these exemplary wireless mediums have features and advantages that make them appropriate for various applications The IEEE 802.11 Wireless LAN Standards describe two major components, a wireless device, called a station (STA), and a fixed access point (AP) wireless device. The AP may perform the wireless-to-wired bridging from STAs to a wired network. The basic network is the basic service set (BSS), which is a group of wireless devices that communicate with each other. An infrastructure BSS is a network that has an AP as an essential node.

The access point (AP) in legacy IEEE 802.11 Wireless LAN networks must relay all communication between the wireless devices (STAs) in an infrastructure BSS. If a STA in an infrastructure BSS wishes to communicate a frame of data to a second STA, the communication must take at minimum two hops. First, the originating STA transfers the frame to the AP. Second, the AP transfers the frame to the second STA.

The access point in an infrastructure BSS assists those wireless devices attempting to save power. For example two different power states may be supported by wireless devices. In the awake state the wireless device is able to transmit or receive frames and is fully powered, while in the doze state the wireless device is not able to transmit or receive and consumes very low power. In the active mode wireless device should be in the awake state all the time and the power save mode where the STAs alternates between awake and doze states. There may be further power save modes.

The legacy IEEE 802.11e Wireless LAN standard provides for support of low power operation in handheld and battery operated STAs, called automatic power save delivery (APSD). A STA currently in the power saving mode, will wake up at predetermined times to receive beacons received from the AP and to listen to a traffic indication map (TIM). If existence of buffered traffic waiting to be sent to the STA is signaled through the TIM, the STA may remain awake and initiate the data transmission from the AP.

There is unscheduled automatic power save delivery (U-APSD) and scheduled automatic power save delivery (S-APSD) defined. In U-APSD, the access point is always awake and hence a STA in the power save mode can send a trigger frame to the AP when the STA wakes up, to retrieve any queued data at the AP and also transmit any data queued from the STA to the AP. In S-APSD, the AP assigns a schedule to a STA and the STA wakes up at the assigned time to retrieve from the AP any data queued for the STA. An AP can maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

A next generation IEEE 802.11 WLAN standard is currently under development, which includes the feature of tunneled direct link setup (TDLS) with channel switching. This feature enables two wireless devices (STAs) in an infrastructure BSS to directly exchange frames of data over a direct data transfer link, without requiring the access point in the infrastructure BSS to relay the frames. In the next generation IEEE 802.11 WLAN standard currently under development, there is defined a basic switching scheme for the PHY channel used in direct link between the base channel (i.e., common channel between the STAs and the AP they are associated with) and the off-channel (i.e., another channel than the base channel that is also possible at another frequency band). The conventional off-channel negotiation and channel switching requires two acknowledged (ACK) messages to be sent between the devices to provide the basis for channel switching, which may delay switching to the new channel.

### SUMMARY

Method, apparatus, and computer program product embodiments are disclosed to improve the channel switching in communication protocols, such as for example the next generation IEEE 802.11 WLAN standard currently under development, by simplifying transmission of only a single, acknowledged switching message to trigger off channel—or base channel switching after an initial off channel configuration and set-up of the direct link. The single message off channel switching indication in direct link is based on two specific timeout timers that serve as a basis for channel switching between the devices in TDLS direct link. An immediate fallback transition is provided to the base channel in the event that the communication in the off-channel does not succeed. The timeouts in the fallback procedure allow continuing the planned data transfer immediately in the base channel of the TDLS direct link if the switching to the off channel has not succeeded. The two timeouts specify together a simple and reliable mechanism for two client devices with TDLS direct link to exchange frames directly with each other alternating the applied channel for direct link communication between the base channel and the off channel.

An example embodiment of the invention may configure the off channel by transmitting a channel switch configuration request from a wireless device to another wireless device to configure the off channel switch parameters. The request may include PHY parameters for the off channel, an off channel waiting period during which at least one message is exchanged successfully between the devices over the off channel. The request may further include a base channel waiting period in the channel switch request, during which the devices should stay awake at the base channel in the event of their unsuccessful communication over the off channel. The request may be responded with the channel switch configuration response.

An embodiment of the invention may transmit an indication from the wireless device to the other wireless device to trigger switching from the TDLS base channel to the off channel. The transmission of the indication may start a first timer measuring the off channel waiting period. The transmission of the indication may start a second timer measuring the base channel waiting period.

An example embodiment of the invention may continue to operate in the TDLS base channel if a message is not successfully exchanged over the off channel within the off channel waiting period. An embodiment of the invention may switch operation from the TDLS base channel to the off channel if at least one message is exchanged successfully between the devices over the off channel. An embodiment of the invention may continue operation in the off channel until a channel switch indication is successfully exchanged.

An example embodiment of the invention may initiate communication on the TDLS base channel during the base channel waiting period in the event of an unsuccessful establishment of communication or unsuccessful switch procedure to the off channel.

An example embodiment of the invention may negotiate between the devices for values of the off channel waiting period and the base channel waiting period.

An example embodiment of the invention may have the off channel waiting period and/or the base channel waiting period either predefined or negotiated.

The resulting example embodiments provide a lower overhead in the number of frames and lower access delay required to successfully switch channels.

### DESCRIPTION OF THE FIGURES

FIG. 1A is an example network diagram of an infrastructure BSS network, with two wireless devices and an access point, operating in associated mode, i.e. transmitting all traffic from one wireless device STA to the access point AP, which relays the traffic to the other wireless device STA, using two hops.

FIG. 1B is an example network diagram of the infrastructure BSS network of FIG. 1A, operating in TDLS direct link mode where one wireless device communicates with another wireless device over a direct link without going through the access point.

FIG. 1C is an example network diagram of the infrastructure BSS network of FIG. 1A, showing the TDLS direct link 110 operating in the base channel 116 wherein the TDLS direct link 110 transmissions are performed in the same channel that used by the AP.

FIG. 1D is an example network diagram of the infrastructure BSS network of FIG. 1A, showing the TDLS direct link 110 operating in the off channel 112 wherein the TDLS direct link 110 transmissions are performed in a different channel than that used by the AP.

FIG. 1E illustrates an external view and a functional block diagram of an example embodiment of the wireless device.

FIG. 2 is an example signaling diagram of an example embodiment using the peer traffic indication (PTI) to trigger a channel switching operation, in the case of encountering no problems in successfully completing a channel switch operation. FIGS. 2A through 2U illustrate example frames and message transfer paths for the example sequence of signals shown in FIG. 2.

FIG. 2A is a generalized representation of an example TDLS Setup Request with Power Save Support Indication frame according to an example embodiment and FIG. 2B is an example network diagram of the infrastructure BSS network of FIG. 1A operating in the infrastructure BSS mode, wherein the setup request frame of FIG. 2A communicates a tunneled direct link setup (TDLS) Setup Request with Power Save Support Indication according to an example embodiment.

FIG. 2C is a generalized representation of an example TDLS Setup Response with Power Save Support Indication frame according to an example embodiment and FIG. 2D is an example network diagram of the infrastructure BSS network of FIG. 1A operating in the infrastructure BSS mode, wherein the setup response frame of FIG. 2C communicates a TDLS Setup Response with Power Save Support Indication according to an example embodiment.

FIG. 2E is a generalized representation of an example channel switch configuration request frame according to an example embodiment and FIG. 2F is an example network diagram of the infrastructure BSS network of FIG. 1B operating in the TDLS direct link mode, wherein the channel switch request frame of FIG. 2E configures the off-channel according to an example embodiment. Suggested example values for an off channel waiting time (OCWT) and a base channel waiting time (BCWT) are included in the request according to at least one embodiment.

FIG. 2G is a generalized representation of an example channel switch configuration response frame according to an example embodiment and FIG. 2H is an example network diagram of the infrastructure BSS network of FIG. 1B operating in the TDLS direct link mode, wherein the channel switch response frame of FIG. 2G configures the off-channel according to an example embodiment. Example accepted values or alternate suggested values are negotiated for the off channel waiting time (OCWT) and the base channel waiting time (BCWT) included in the response according to at least one embodiment.

FIG. 2I is a generalized representation of an example frame signaling by the sender to the access point that the sender is operating in power save mode with respect to the access point after successful transmission of the frame according to an example embodiment. This frame is transmitted from STA1 to AP according to at least one embodiment. This frame may not be forwarded by AP to STA2. FIG. 2J is an example network diagram of the infrastructure BSS network of FIG. 1A operating in the infrastructure BSS mode according to an example embodiment. Both wireless devices transition independent of each other to the PS power management mode with respect to the access point by transmitting the frame of FIG. 2I to the access point according to at least one embodiment.

FIG. 2K is a generalized representation of an example off channel switch indication frame according to an example embodiment and FIG. 2L is an example network diagram of the infrastructure BSS network of FIG. 1B operating in the TDLS direct link mode, wherein the off channel switch indication frame of FIG. 2L communicates an off channel switch indication using the peer traffic indication (PTI) to trigger a channel switch that is based on the negotiated off channel waiting time (OCWT) and the negotiated base channel waiting time (BCWT) according to at least one embodiment.

FIG. 2M is a generalized representation of an example data traffic frame according to an example embodiment and FIG. 2N is an example network diagram of the infrastructure BSS network of FIG. 1B operating in the TDLS direct link mode, wherein the data traffic frame of FIG. 2M communicates data traffic between the wireless devices over the direct link off channel after a successful switch from base channel operation according to at least one embodiment.

FIG. 2O is a generalized representation of an example end of session frame according to an example embodiment and FIG. 2P is an example network diagram of the infrastructure BSS network of FIG. 1B operating in the TDLS direct link mode, wherein the end of session frame of FIG. 2P communicates the end of the session between the wireless devices over the direct link off channel, which will initiate both wireless devices reverting back to the base channel mode operation according to at least one embodiment.

FIG. 2Q is an example network diagram of the infrastructure BSS network of FIG. 1A operating in the TDLS direct link mode, wherein the two wireless devices have reverted back to operating in the base channel mode according to at least one embodiment.

FIG. 2R is a generalized representation of an example off channel switch indication frame according to an example embodiment and FIG. 2S is an example network diagram of the infrastructure BSS network of FIG. 1B operating in the off channel mode, wherein the off channel switch indication frame of FIG. 2R communicates an off channel switch indication using the peer traffic indication (PTI) to trigger a channel switch that is based on the negotiated off channel waiting time (OCWT) and the negotiated base channel waiting time (BCWT) according to at least one embodiment. These operations are the same as in FIG. 2L.

FIG. 2T is a generalized representation of an example data traffic frame according to an example embodiment and FIG. 2U is an example network diagram of the infrastructure BSS network of FIG. 1B operating in the off channel mode, wherein the data traffic frame of FIG. 2T communicates data traffic between the wireless devices over the direct link off channel after a successful switch from base channel operation in FIG. 2Q according to at least one embodiment. These operations are the same as in FIG. 2N.

FIG. 3 is an example signaling diagram of a case where the communication on the off channel is not successful according to at least one embodiment.

FIG. 4 is an example signaling diagram of a case where one station is having a service period (SP) while a switch channel indication is received according to at least one embodiment.

FIG. 5 is an example signaling diagram of a case where one wireless device is having a service period (SP) while it should be available in the off channel according to agreed schedule according to at least one embodiment.

FIG. 6 is an example signaling diagram of the base channel waiting time (BCWT) period usage with the off channel switch procedure, according to at least one embodiment.

### DISCUSSION OF EXAMPLE EMBODIMENTS OF THE INVENTION

U.S. patent application Ser. No. 12/118,207 to Naveen Kakani and Jakub Majkowski, filed May 9, 2008, entitled “Power Save Mechanism For Wireless Communication Devices”, is incorporated herein by reference for its disclosure of various related power save modes of operation between wireless devices.

U.S. patent application Ser. No. 12/172,397 to Jarkko Kneckt, Janne Marin, Mika Kasslin, and Jakub Majkowski, filed Jul. 14, 2008, entitled “Power Save Enhancements For Wireless Communication Devices”, is incorporated herein by reference for its disclosure of direct data transfer in an infrastructure BSS.

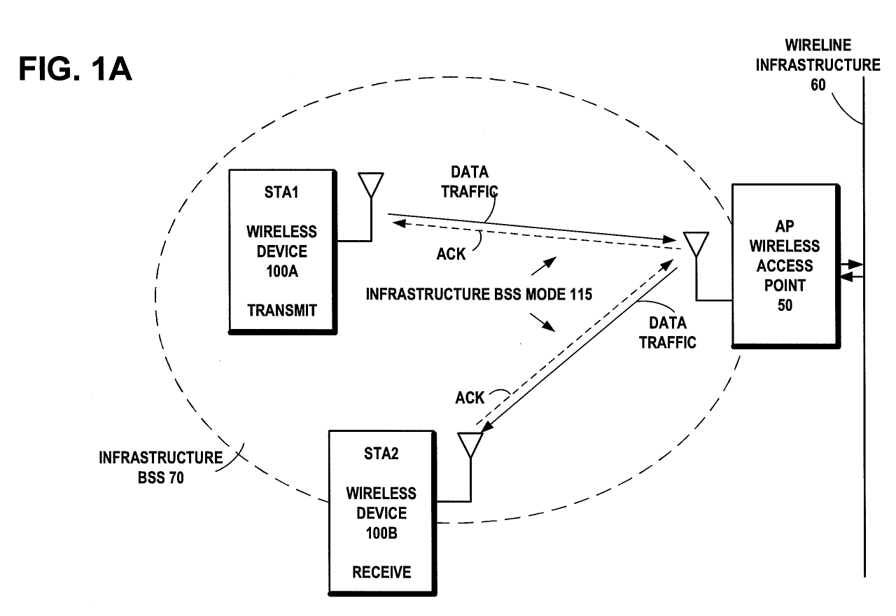

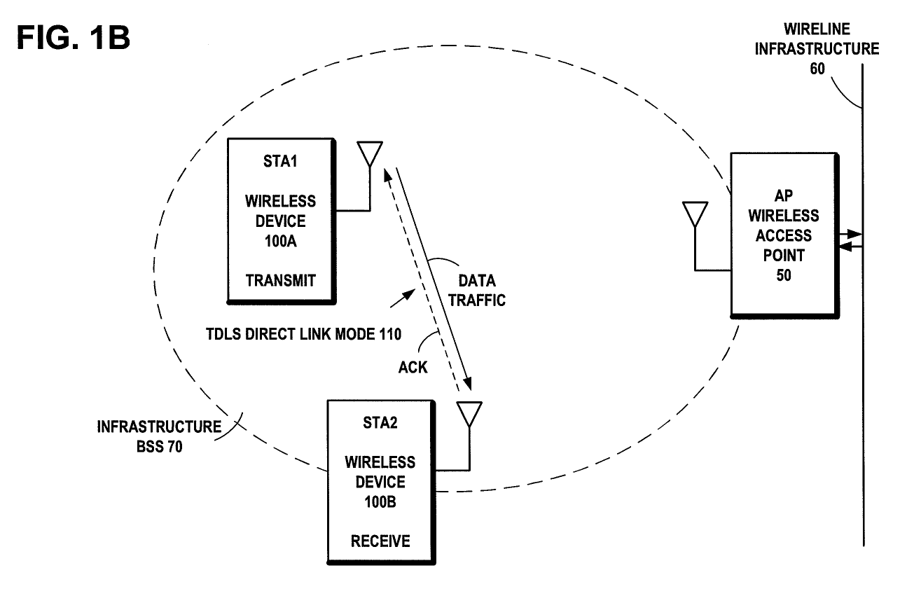

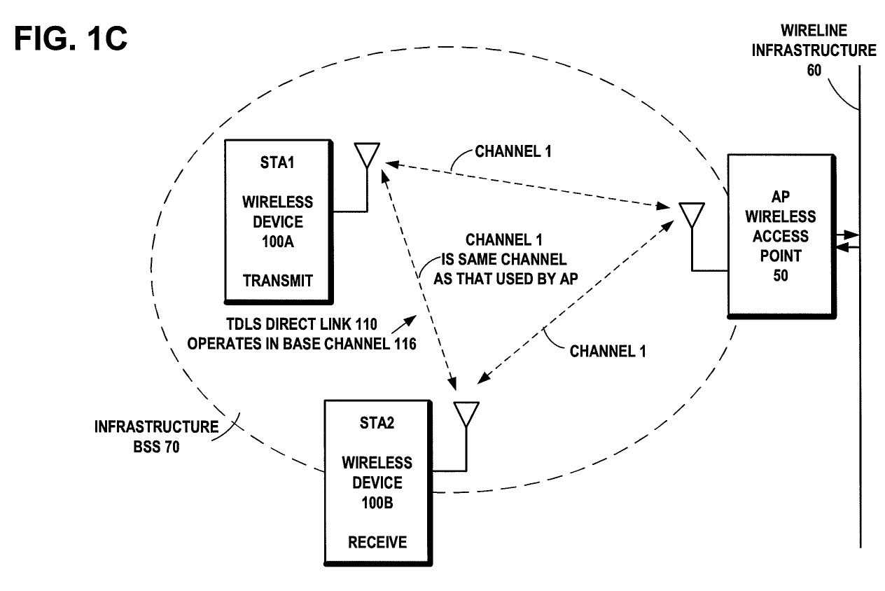

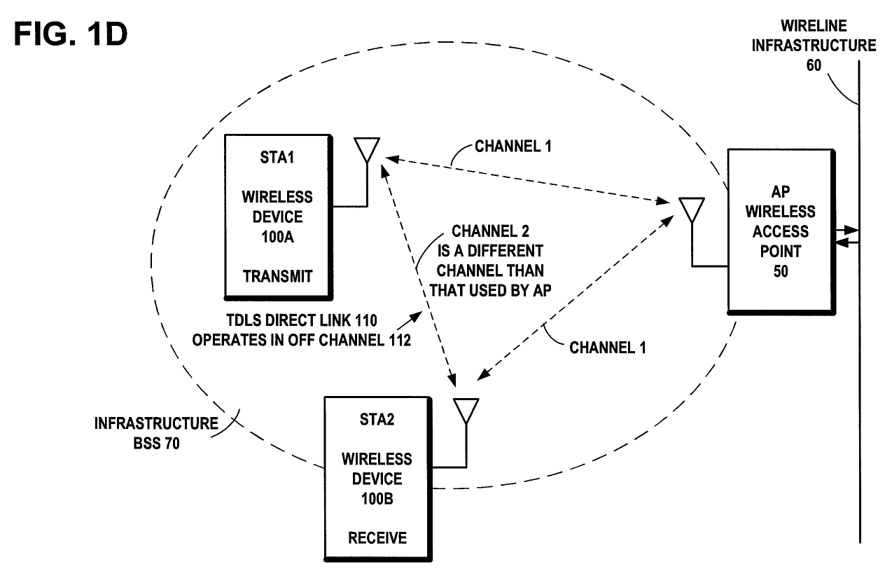

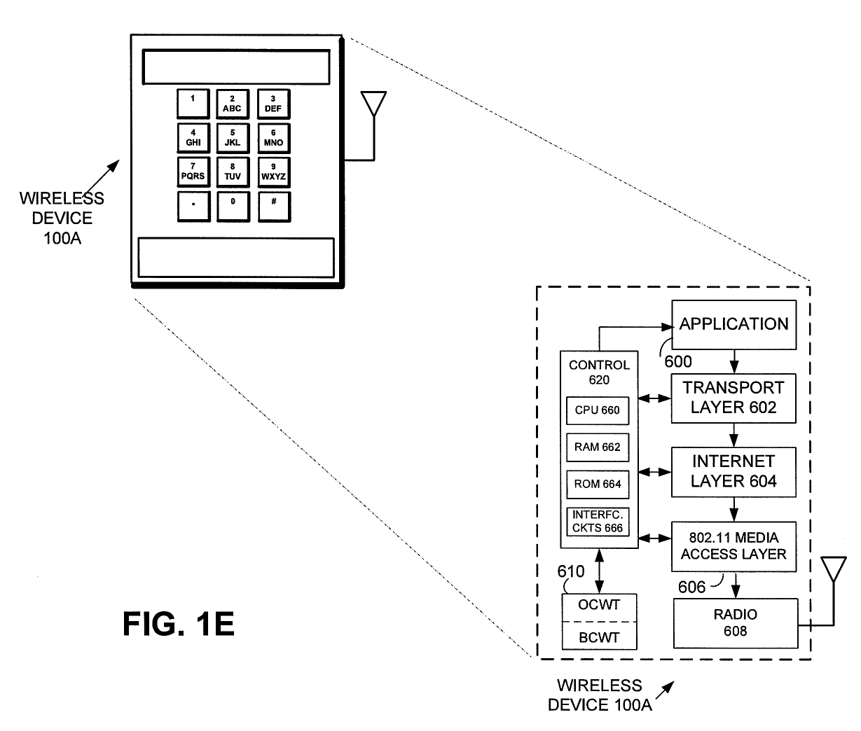

FIG. 1A is an example network diagram of an infrastructure BSS network 70, with two wireless devices 100A and 100B and an access point 50, operating in the infrastructure BSS mode 115 where one wireless device 100A communicates with another wireless device 100B through the access point 50, using two hops. The access point 50 may be connected to a wireline infrastructure 60. The next generation IEEE 802.11 WLAN standard currently under development, includes the feature of tunneled direct link setup (TDLS) with channel switching. FIG. 1B is an example network diagram of the infrastructure BSS network of FIG. 1A, operating in the TDLS direct link mode 110 where one wireless device 100A communicates with another wireless device 100B over a TDLS direct link 110 without going through the access point 50. This feature enables two wireless devices (STAs) 100A and 100B in an infrastructure BSS 70 to directly exchange frames of data over a direct data transfer link 110, without requiring the access point 50 in the infrastructure BSS to relay the frames.

The base channel 116 and off channel 112 defines the channel that carries the transmissions on the TDLS direct link 110. FIG. 1C is an example network diagram of the infrastructure BSS network of FIG. 1A, showing the TDLS direct link 110 operating in the base channel 116 wherein the TDLS direct link 110 transmissions are performed in the same channel, example channel 1, that is used by the AP. If the TDLS direct link 110 transmissions are performed in the same channel that the AP 50 uses, the TDLS direct link 110 operates in the base channel 116. FIG. 1D is an example network diagram of the infrastructure BSS network of FIG. 1A, showing the TDLS direct link 110 operating in the off channel 112 wherein the TDLS direct link 110 transmissions are performed in a different channel, example channel 2, than the example channel 1 used by the AP 50. If the transmissions on the TDLS direct link 110 are done in some other channel, usually non overlapping with the base channel, the TDLS direct link 110 uses off channel 112. By using the off channel 112 for TDLS direct link 110, the capacity of the TDLS direct link 110 and the BSS 70 to which devices 100A and 100B are associated may be increased.

Example embodiments are disclosed herein to improve the channel switching in communication protocols by simplifying transmission of only a single, acknowledged switching message to trigger channel switching after an initial off channel negotiation and set-up of the direct link. The single message switching indication is based on two specific timeout timers that serve as a basis for channel switching between the devices. The timers measure the off channel waiting time (OCWT) and the base channel waiting time (BCWT). An immediate fallback transition is provided to the base channel 116 of the TDLS direct link 110 in the event that the communication in the off channel 112 of the direct link 110 does not succeed within the off channel waiting time (OCWT). The timeouts in the fallback procedure allow continuing the planned data transfer immediately in the base channel 116 during the base channel Waiting time (BCWT) if the switching to the off channel 112 has not succeeded. The two timeouts, OCWT and BCWT, specify together a simple and reliable mechanism for two client devices 100A and 100B to exchange frames directly with each other using two different channels, the base channel 116 and the off channel 112. An example embodiment of the invention may have the off channel waiting period and/or the base channel waiting period either predefined or negotiated.

An example embodiment of the invention may transmit a channel switch configuration request from a wireless device 100A to another wireless device 100B to configure switch from a base channel 115 to an off channel 110. The request may include PHY parameters for the off channel, an off channel waiting period OCWT during which at least one message is exchanged successfully between the devices 100A and 100B over the off channel 112. The request may further include a base channel waiting period BCWT in said channel switch request, during which the devices 100A and 100B should stay awake at the base channel 116 in the event of their unsuccessful communication over the off channel 112. An embodiment of the invention may transmit an indication from the wireless device 100A to the other wireless device 100B to trigger switching from the base channel 116 to the off channel 112. The transmission of the indication may start a first timer measuring the off channel waiting period OCWT. The transmission of the indication may start a second timer measuring the base channel waiting period BCWT.

An example embodiment of the invention may initiate communication on the base channel 116 during the base channel waiting period BCWT in the event of an unsuccessful establishment of communication or unsuccessful switch procedure to the off channel 112. An example embodiment of the invention may attempt communication in a different channel or band in the event that an acknowledgement (ACK) is lost for the indication. The embodiment may then initiate communication on the base channel 116 during the base channel waiting period BCWT in the event of failing to communicate in an off channel 112. An example embodiment of the invention may negotiate between the devices 100A and 100B for values of the off channel waiting period OCWT and the base channel waiting period BCWT. The resulting example embodiments provide a lower overhead in the number of frames and lower access delay required to successfully switch channels.

FIG. 1E illustrates an external view and a functional block diagram of an example embodiment of the wireless device (STA) 100A or 100B. The wireless device 100A may be a communications device, PDA, cell phone, laptop or palmtop computer, or the like. The wireless device 100A includes a control module 620, which includes a central processing unit (CPU) 660, a random access memory (RAM) 662, a read only memory (ROM) 664, and interface circuits 666 to interface with the radio transceiver 608, battery and other power sources, key pad, touch screen, display, microphone, speakers, ear pieces, camera or other imaging devices, etc. in the devices 100A and 100B. The RAM 662 and ROM 664 can be removable memory devices such as smart cards, SIMs, WIMs, semiconductor memories such as RAM, ROM, PROMS, flash memory devices, etc. The wireless device 100A includes for example an Internet protocol stack that includes the user's application program 600 at the top, the Transmission Control Protocol (TCP) transport layer 602, and the Internet Protocol (IP) layer 604, the 802.11 Media Access Control (MAC) layer 606, and the radio transceiver physical layer 608 at the bottom of the protocol stack. The 802.11 MAC layer provides functionality to allow reliable data delivery for the upper layers over the wireless medium. The 802.11 MAC layer may use the next generation IEEE 802.11 WLAN standard currently under development, which includes the feature of direct link setup. The device may support other upper layer protocols, such as for example User Datagram Protocol (UDP).

The control module 620, internet protocol stack layers 602, 604, 606, and/or application program 600 can be embodied as program logic stored in the RAM 662 and/or ROM 664 in the form of sequences of programmed instructions which, when executed in the CPU 660, carry out the functions of the disclosed embodiments. The program logic can be delivered to the writeable RAM, PROMS, flash memory devices, etc. 662 of the wireless device 100A from a computer program product or article of manufacture in the form of computer-usable media such as resident memory devices, smart cards or other removable memory devices, or in the form of program logic transmitted over any transmitting medium which transmits such a program. Alternately, they can be embodied as integrated circuit logic in the form of programmed logic arrays or custom designed application specific integrated circuits (ASIC). The radio 608 in wireless device 100A can be separate transceiver circuits or alternately, the radio 608 can be a single radio module capable of handling one or multiple channels in a high speed, time and frequency multiplexed manner in response to the control module 620.

A memory register 610, which may be a partition in the memory RAM 662, may store the values for the off channel waiting period OCWT and the base channel waiting period BCWT negotiated between the devices 100A and 100B.

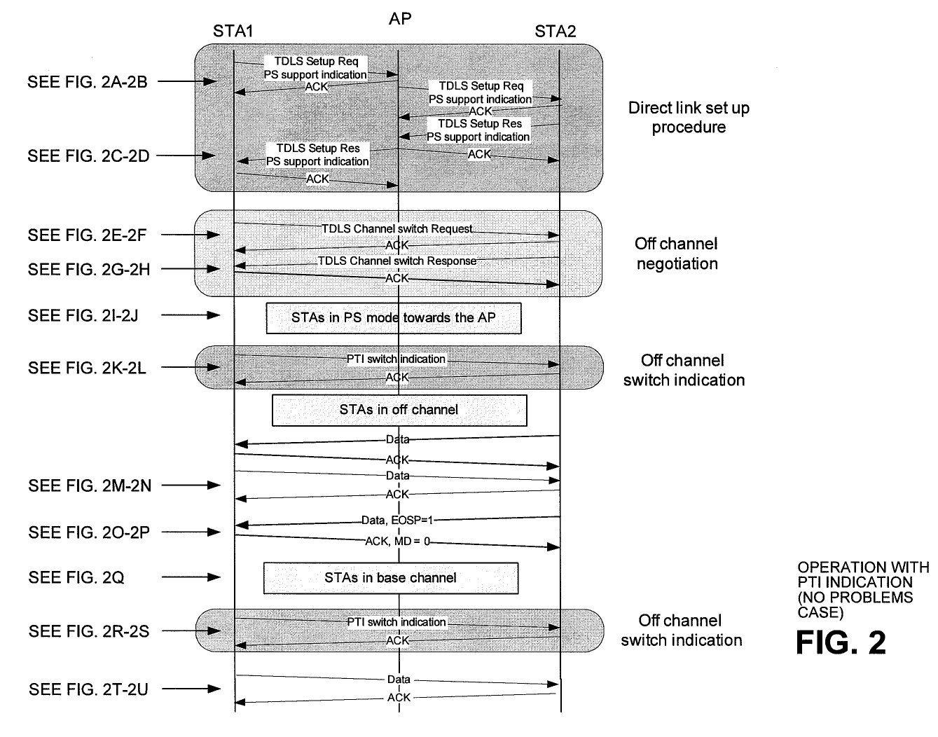

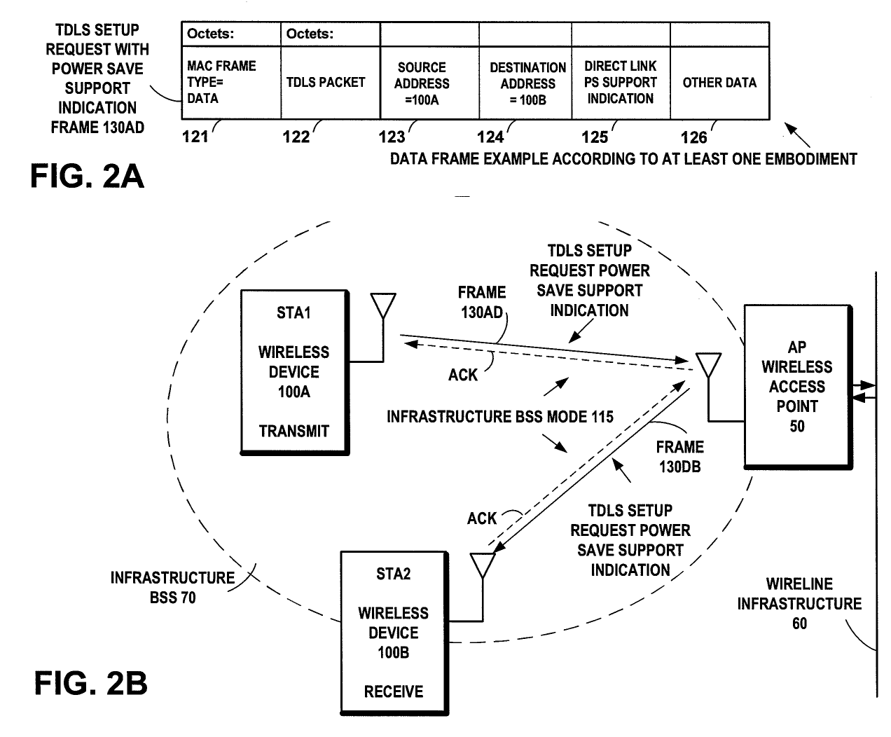

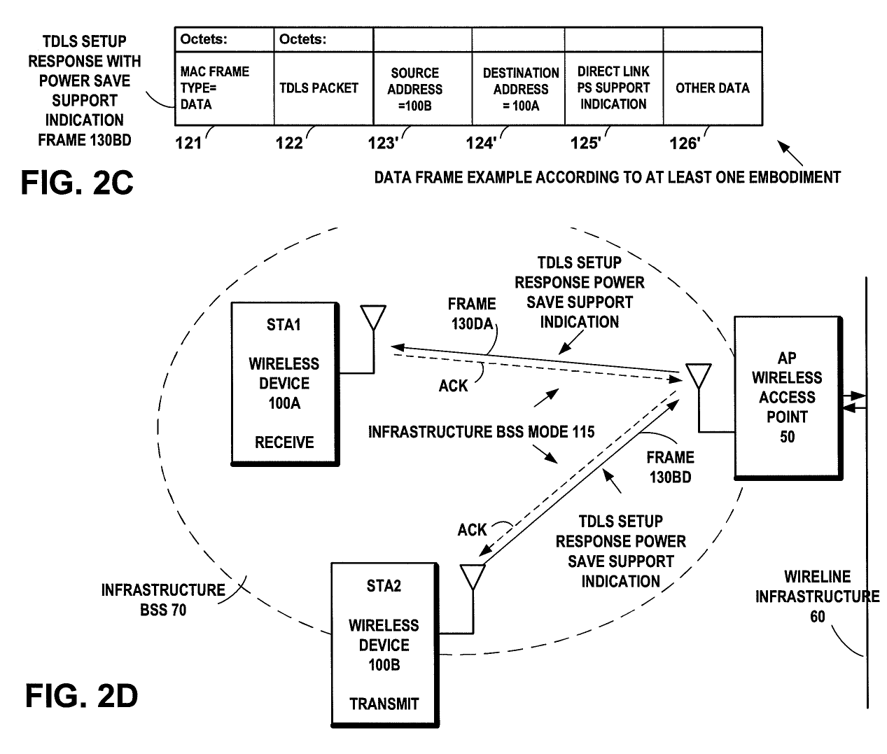

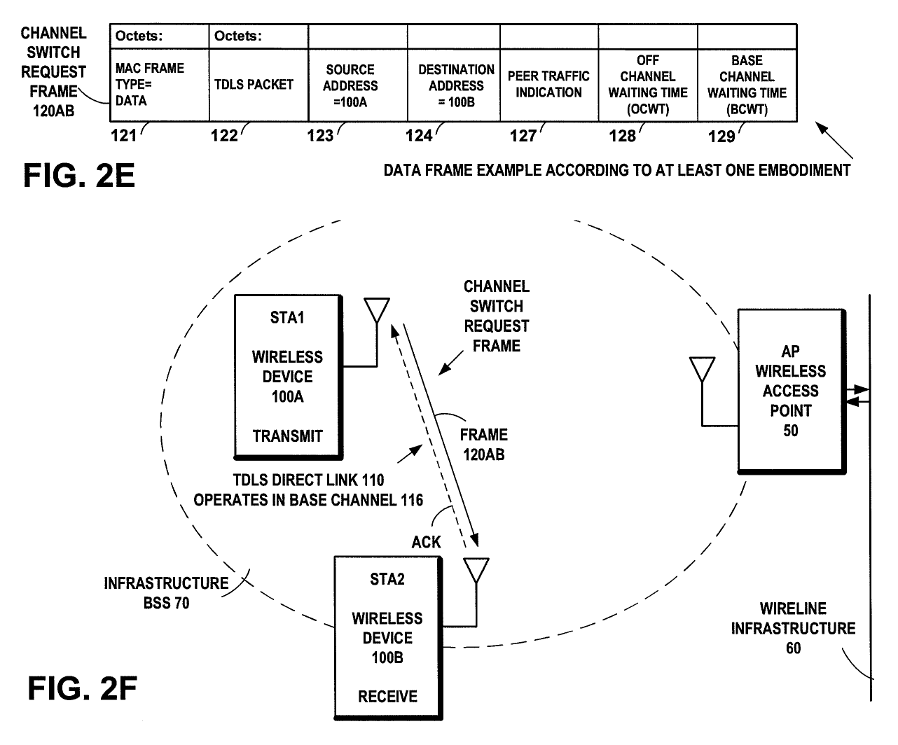

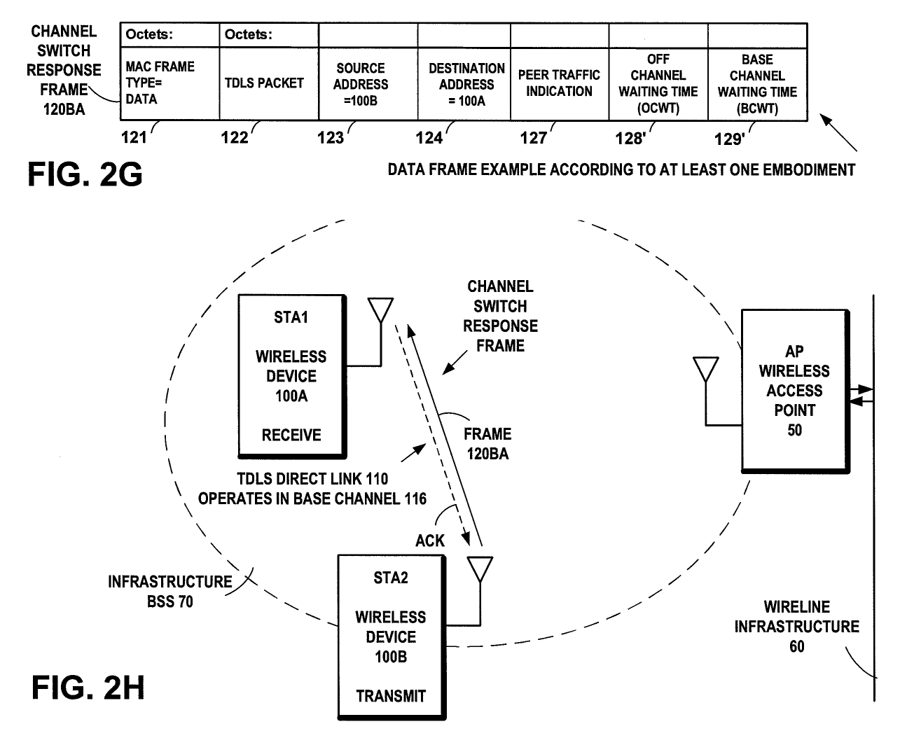

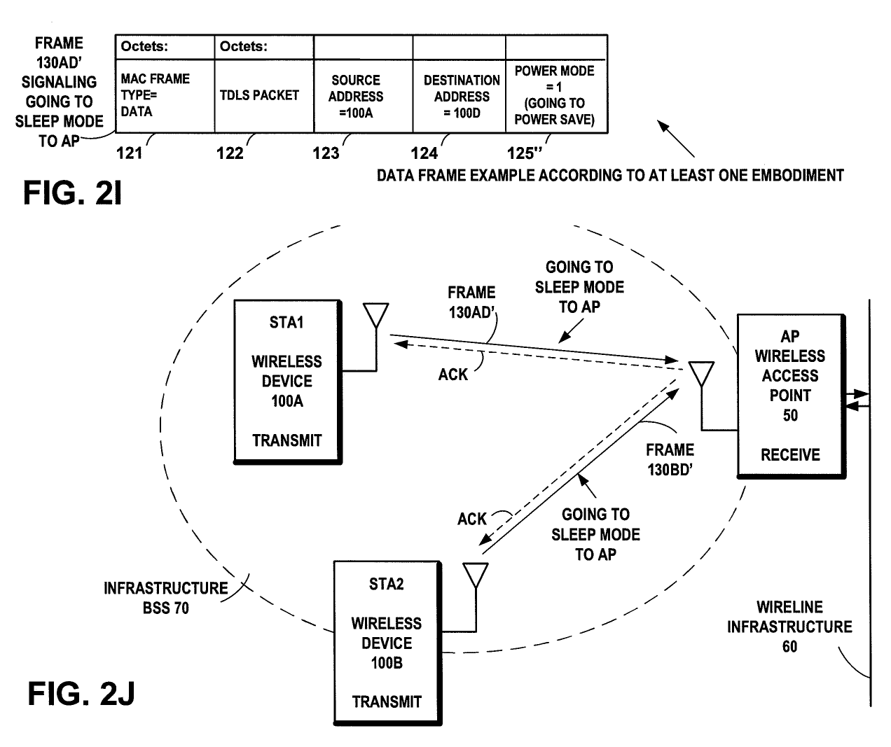

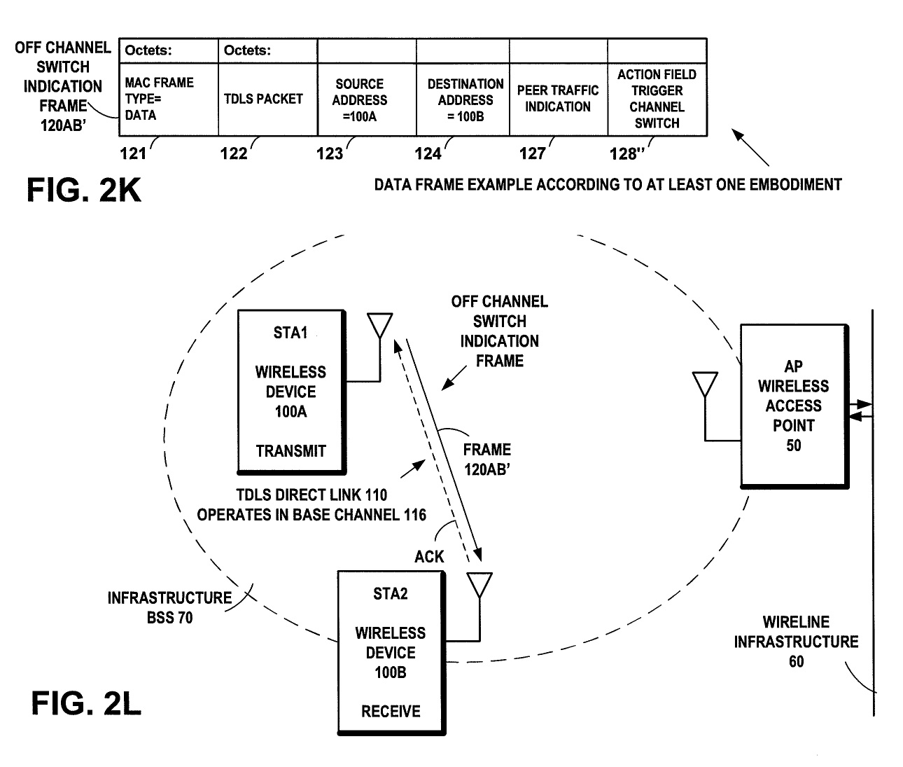

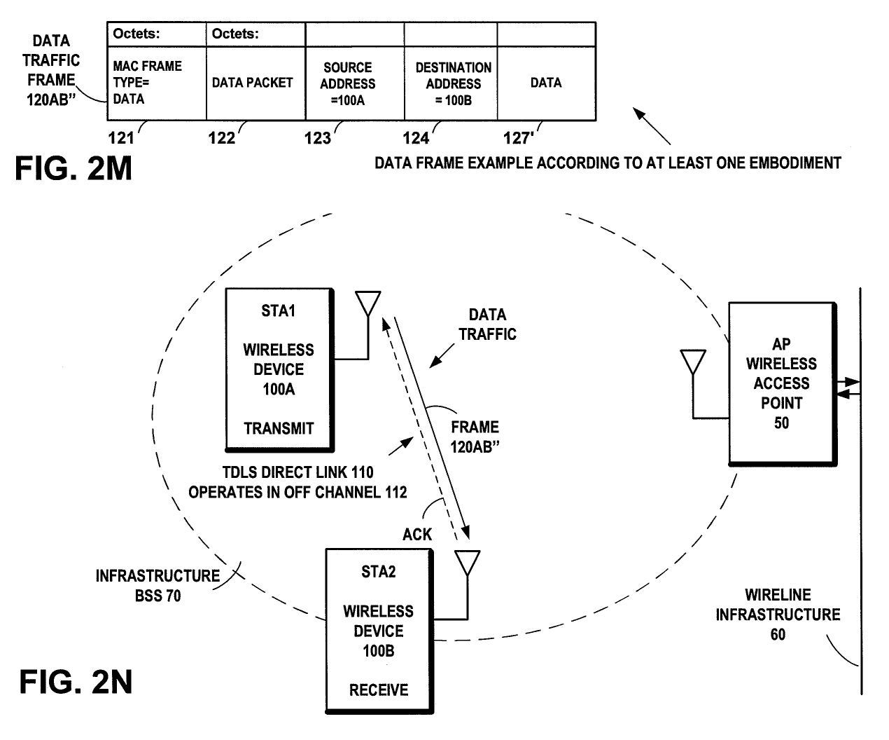

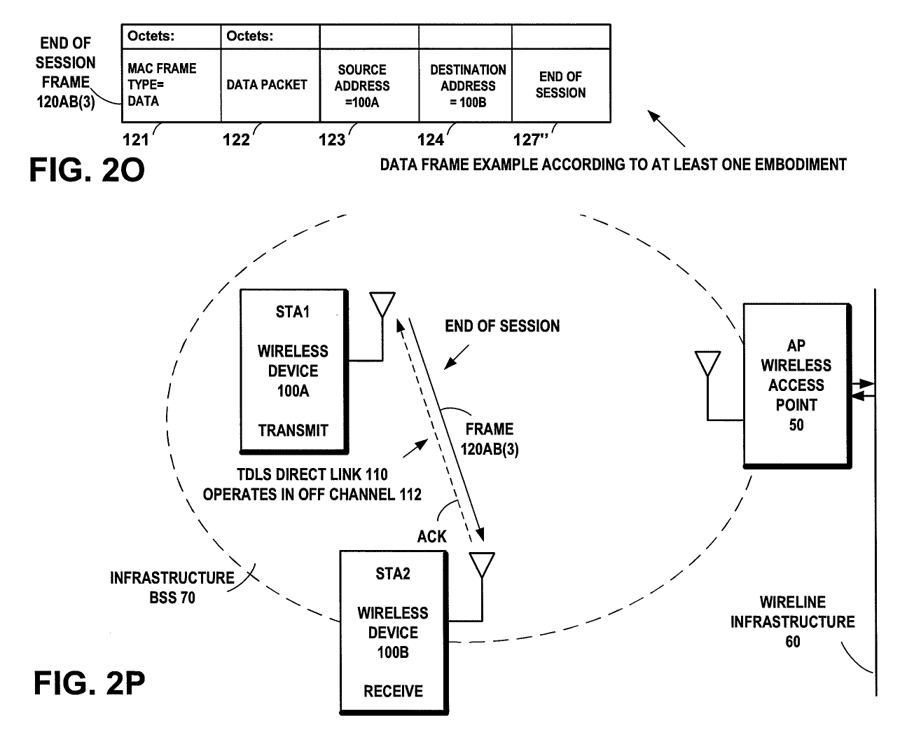

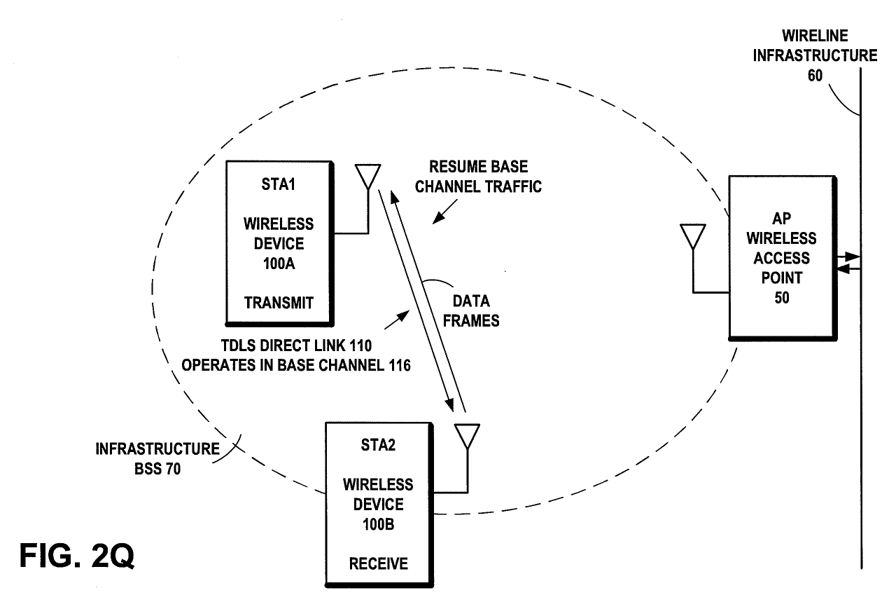

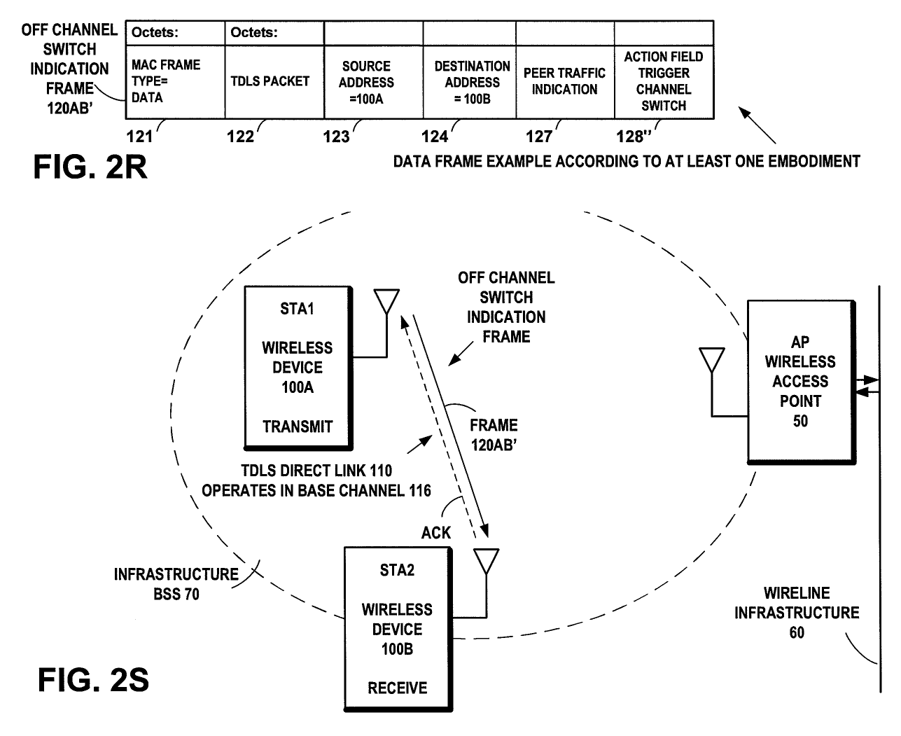

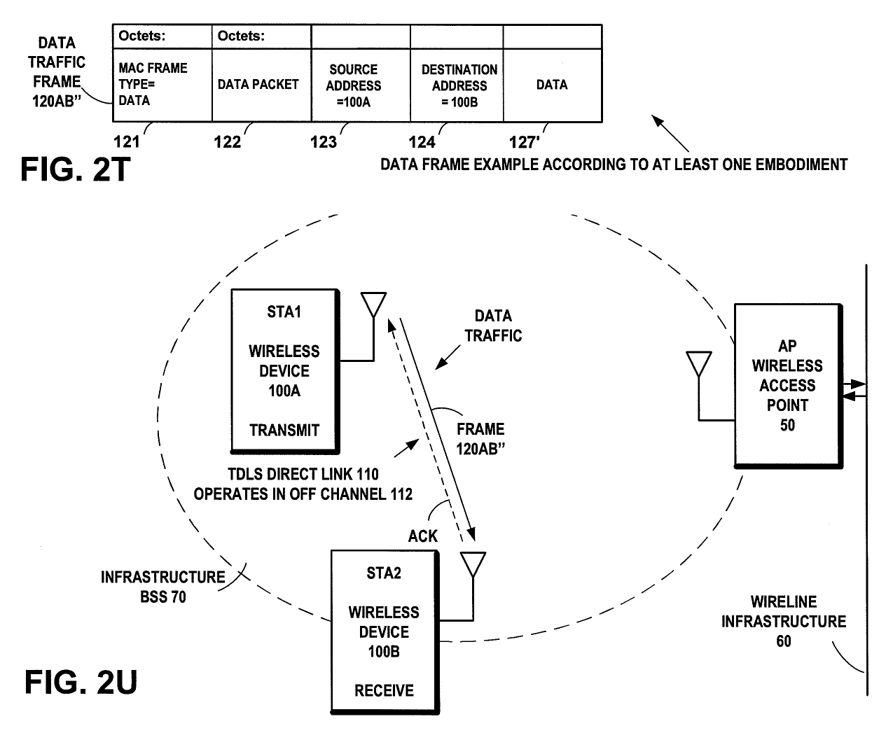

FIG. 2 is an example signaling diagram of an example embodiment using the peer traffic indication (PTI) to trigger a channel switching operation, in the case of encountering no problems in successfully completing a channel switch operation.

The example embodiments provide a new mechanism for off channel (multichannel/multiband) transition. The off channel operation procedure may include, for example:
Off channel parameter negotiation phase.
Single frame based channel switch indication to start operation in a new channel,
Switch timeout definitions containing off channel waiting time and base channel waiting time,
Mechanism to assure base channel fallback in case of unsuccessful off channel switch,
Peer Power Save Mode (PPSM) channel switch improvements; improved reliability when PPSM uses off channel by enabling recovery/frame transmission at base channel.

The example embodiments are operational in all power modes (power save variants and without power save). The off channel transition mechanism is error tolerant and reduces delay in the channel switch by decreasing the number of frames and Transmission Opportunities (TXOP) that have to be exchanged for a channel switch. Additionally, example embodiments allow defining a new logic to identify whether communication over off channel is feasible.

As one embodiment, the base channel waiting period BCWT may be used with peer power save mode (PPSM) that is configured to operate in off channel. When PPSM is configured to operate in off channel, the direct link STAs periodically wakeup at off channel. The use of BCWT with PPSM and off channel operation allows a STA to exchange frames in the base channel at scheduled wake time in case of problems with off channel switch and so that frame transmission delays are reduced. The BCWT makes the coordination of the operation channel easier and robust. The BCWT may be included to prior art off-channel switch signaling. In this case the BCWT provides simple recovery from the failure of the off-channel use.

FIGS. 2A through 2U illustrate example frames and message transfer paths for the example sequence of signals shown in FIG. 2. The data frames are examples according to at least one embodiment. For example, the frames may be defined in the IEEE 802.11 reaff 2007 standard, which is incorporated herein by reference.

The channel switch configuration request in FIG. 2E includes a new field for BCWT. The channel switch configuration response in FIG. 2G includes a new field for BCWT. The BCWT field is two octets in length and may be set to the time in units of 16 microseconds the STA waits for the first data frame exchange on the base channel, if the frames transmission in off channel has not been successful during the OCWT time. The STA shall remain in awake state until the BCWT is expired or a frame from the peer STA is received. The time is measured from the end of the ACK frame in response to TDLS Channel Switch Indication frame. Frames transmitted in direct link have “toDS” and “fromDS” bits in frame control field in MAC header set to 00, 10 destined to AP and 01 from AP to STA. The EOSP bit is present in the QoS control field.

FIG. 2A is a generalized representation of an example frame 130AD for TDLS Setup Request with Power Save Support Indication according to an example embodiment. Frame 130AD is transmitted from wireless device 100A to the access point 50, which will be forwarded in frame 130DB to the wireless device 100B. FIG. 2B is an example network diagram of the infrastructure BSS network 70 of FIG. 1A operating in the BSS Infrastructure mode 115, wherein the example frame 130AD for TDLS Setup Request with Power Save Support Indication of FIG. 2A communicates a tunneled direct link setup (TDLS) setup request that is forwarded to wireless device 100B. The frame 130AD may include MAC frame type field 121, TDLS packet field 122, source address field 123, destination address field 124, direct link power save (PS) support indication field 125, and other data 126. The frame structures are examples according to at least one embodiment. Acknowledgement frames (ACK) are returned.

FIG. 2C is a generalized representation of an example frame 130BD for TDLS Setup Response with Power Save Support Indication according to an example embodiment. Frame 130BD is transmitted from wireless device 100B to the access point 50, which will be forwarded in frame 130DA to the wireless device 100A. FIG. 2D is an example network diagram of the infrastructure BSS network 70 of FIG. 1A operating in the BSS infrastructure mode 115, wherein the example frame 130BD for TDLS Setup Response with Power Save Support Indication of FIG. 2C communicates a TDLS setup response. The fields of frame 130BD may be similar to those of frame 130AD. The frame structures are examples according to at least one embodiment. Acknowledgement frames (ACK) are returned.

FIG. 2E is a generalized representation of an example channel switch request frame 120 AB from wireless device 100A to wireless device 100B. The channel switch request frame may be also be forwarded through the AP. FIG. 2F is an example network diagram of the infrastructure BSS network 70 of FIG. 1B operating in the off channel mode 110, wherein the channel switch request frame 120 AB of FIG. 2E communicates a channel switch request using the peer traffic indication (PTI). Suggested values for an off channel waiting time (OCWT) and a base channel waiting time (BCWT) are included in fields 128 and 129 of the request. The frame structures are examples according to at least one embodiment. The BCWT field is two octets in length and set to the time in units of 16 microseconds the STA waits for the first data frame exchange on the base channel, if the frames transmission in off channel has not been successful during the OCWT time. The STA shall remain in awake state until the BCWT is expired or a frame from the peer STA is received. The time is measured from the end of the ACK frame in response to TDLS Channel Switch Indication frame. Frames transmitted in direct link have “toDS” and “fromDS” bits in frame control field in MAC header set to 00. An acknowledgement frame (ACK) is returned.

FIG. 2G is a generalized representation of an example channel switch response frame 120BA from wireless device 100B to wireless device 100A. The channel switch response frame may be also be forwarded through the AP. FIG. 2H is an example network diagram of the infrastructure BSS network 70 of FIG. 1B operating in the off channel mode 110, wherein the channel switch response frame 120BA of FIG. 2G communicates a channel switch response using the peer traffic indication (PTI). Accepted values or alternate suggested values are negotiated for the off channel waiting time (OCWT) and the base channel waiting time (BCWT) included in fields 128′ and 129′ of the response. Register 610 in each wireless device 100A and 100B stores the values for the off channel waiting period OCWT and the base channel waiting period BCWT negotiated between the devices 100A and 100B. The OCWT and BCWT values may be negotiated during the off channel negotiation. The default OCWT and BCWT values are PHY specific. Exemplary values may include 6 ms for IEEE 802.11b and 3 ms for IEEE 802.11a, g and n. The frame structures are examples according to at least one embodiment. The BCWT field is two octets in length and set to the time in units of microseconds the STA waits for the first data frame exchange on the base channel, if the frames transmission in off channel has not been successful during the OCWT time. The STA shall remain in awake state until the BCWT is expired or a frame from the peer STA is received. The time is measured from the end of the ACK frame in response to TDLS Channel Switch Indication frame. Frames transmitted in direct link have “toDS” and “fromDS” bits in frame control field in MAC header set to 00. An acknowledgement frame (ACK) is returned. An example embodiment of the invention may have the off channel waiting period and/or the base channel waiting period either predefined or negotiated.

FIG. 2I is a generalized representation of an example frame 130AD′ signaling by the sender wireless device 100A to the access point 50 that the sender 100A is going to the power save sleep mode with respect to the access point 50 in the BSS infrastructure mode 115. Wireless device 100B sends a similar frame 130BD′ to the access point 50. FIG. 2J is an example network diagram of the infrastructure BSS network 70 of FIG. 1A operating in the BSS infrastructure mode 115, wherein both of the wireless devices 100A and 100B transition to the power save sleep mode with respect to the access point 50 by transmitting the frames of FIG. 2I to the access point 50. An acknowledgement frame (ACK) is returned.

FIG. 2K is a generalized representation of an example off channel switch indication frame 120 AB′ from wireless device 100A to wireless device 100B to trigger a channel switch. FIG. 2L is an example network diagram of the infrastructure BSS network 70 of FIG. 1B operating in the off channel mode 110, wherein the off channel switch indication frame 120AB′ of FIG. 2L communicates an off channel switch indication using the peer traffic indication (PTI) to trigger a channel switch that is based on the negotiated off channel waiting time (OCWT) and the negotiated base channel waiting time (BCWT). The frame structures are examples according to at least one embodiment. Frames transmitted in direct link have “toDS” and “fromDS” bits in frame control field in MAC header set to 00. An acknowledgement frame (ACK) is returned.

FIG. 2M is a generalized representation of an example data traffic frame 120AB″ from wireless device 100A to wireless device 10B. FIG. 2N is an example network diagram of the infrastructure BSS network 70 of FIG. 1B operating in the off channel mode 110, wherein the data traffic frame 120AB″ of FIG. 2M communicates data traffic between the wireless devices 100A and 100B over the direct link off channel 110 after a successful switch from base channel operation 116. Data frames are as defined in IEEE802.11 reaff 2007. Frames transmitted in direct link have “toDS” and “fromDS” bits in frame control field in MAC header set to 00. An acknowledgement frame (ACK) is returned.

FIG. 2O is a generalized representation of an example end of session frame 120AB(3) from wireless device 100A to wireless device 10B. FIG. 2P is an example network diagram of the infrastructure BSS network 70 of FIG. 1B operating in the off channel mode 110, wherein the end of session (EOSP) frame 120AB(3) of FIG. 2P communicates the end of the session between the wireless devices 100A and 100B over the direct link off channel 110, which will initiate both wireless devices 100A and 100B reverting back to the base channel mode operation 116. The frame structures are examples according to at least one embodiment. The EOSP bit is present in the QoS control field. Frames transmitted in direct link have “toDS” and “fromDS” bits in frame control field in MAC header set to 00. An acknowledgement frame (ACK) is returned.

FIG. 2Q is an example network diagram of the infrastructure BSS network 70 of FIG. 1A operating in the base channel mode 116, wherein the two wireless devices 100A and 100B have reverted back to operating in the base channel mode 116. Data frames are as defined in IEEE802.11 reaff 2007. Frames transmitted in direct link have “toDS” and “fromDS” bits in frame control field in MAC header set to 00. An acknowledgement frame (ACK) is returned.

FIG. 2R is a generalized representation of an example off channel switch indication frame 120 AB′ from wireless device 100A to wireless device 100B to trigger a channel switch. FIG. 2S is an example network diagram of the infrastructure BSS network 70 of FIG. 1B operating in the off channel mode 110, wherein the off channel switch indication frame 120AB′ of FIG. 2R communicates an off channel switch indication using the peer traffic indication (PTI) to trigger a channel switch that is based on the negotiated off channel waiting time (OCWT) and the negotiated base channel waiting time (BCWT). These operations are the same as in FIG. 2L. The frame structures are examples according to at least one embodiment. Frames transmitted in direct link have “toDS” and “fromDS” bits in frame control field in MAC header set to 00. An acknowledgement frame (ACK) is returned.

FIG. 2T is a generalized representation of an example data traffic frame 120AB″ from wireless device 100A to wireless device 10B. FIG. 2U is an example network diagram of the infrastructure BSS network 70 of FIG. 1B operating in the off channel mode 110, wherein the data traffic frame 120AB″ of FIG. 2T communicates data traffic between the wireless devices 100A and 100B over the direct link off channel 110 after a successful switch from base channel operation 116. These operations are the same as in FIG. 2N. Data frames are as defined in IEEE802.11 reaff 2007. Frames transmitted in direct link have “toDS” and “fromDS” bits in frame control field in MAC header set to 00. An acknowledgement frame (ACK) is returned.

The resulting example embodiments provide a lower overhead in the number of frames and lower access delay required to successfully switch channels.

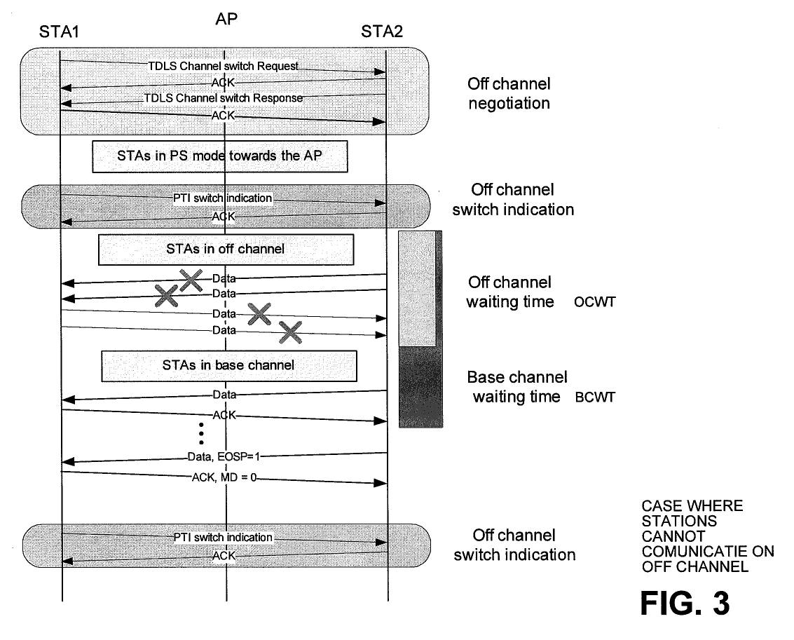

FIG. 3 is an example signaling diagram of a case where the wireless devices cannot communicate on the off channel before the OCWT expires. If stations are not able to communicate in the off channel they should retry transmissions until the off channel waiting time (OCWT) has passed and after that they should switch back to the base channel. While on the base channel stations should stay awake in base channel for at least the remaining duration of base channel waiting time during which they may trigger a direct link service period. In the figure a service period triggering is successful in the base channel.

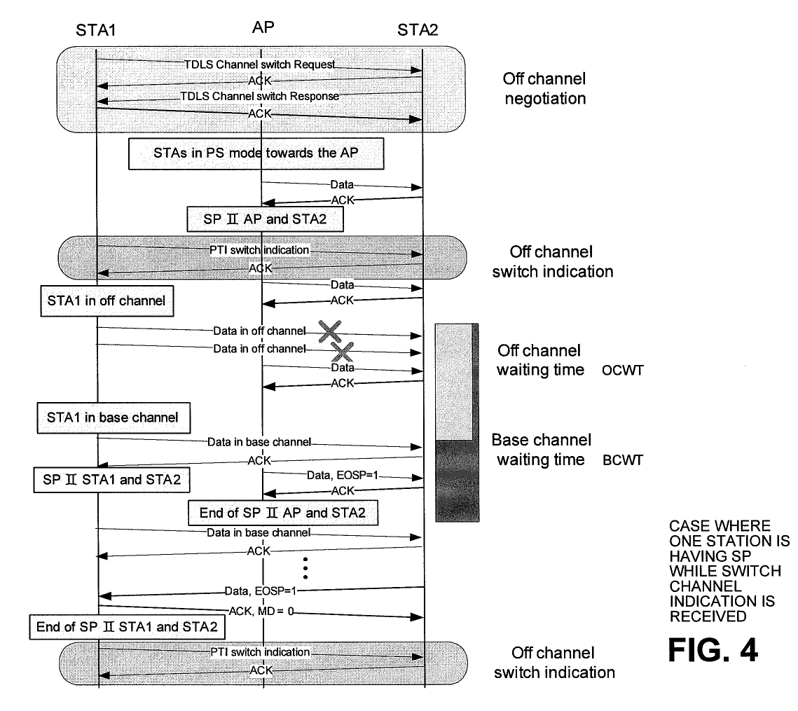

FIG. 4 is an example signaling diagram of a case where one station is having a service period (SP) while a switch channel indication is received. If the responding station at the moment of acknowledging the reception had service period (SP) running with other station (e.g. AP) and it failed to finish the ongoing SP and switch to the new channel during the OCWT time, it must stay awake on the current channel (base channel) for an additional time equal to the BCWT time. At the same time as the requesting station did not get any reply to its frames on the off channel, it must switch back to the base channel after the OCWT time has passed. While both stations are awake on the base channel for the duration of the BCWT, the stations are expected to send a trigger frame to start a service period in direct link.

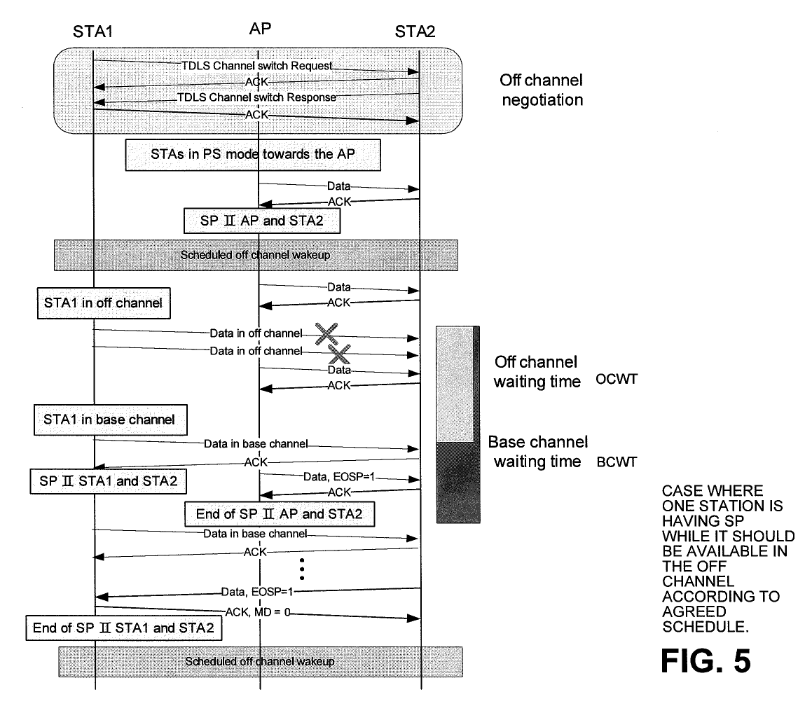

FIG. 5 is an example signaling diagram of a case where one wireless device is having a service period (SP) while it should be available in the off channel according to agreed schedule. In case stations are using scheduled power save scheme (Peer PSM), both stations are expected to be awake on the new channel at scheduled wakeup times. However, one of the stations may be involved in the SP with the AP before and during the scheduled wakeup and hence it will not be available on the off channel at the same time. In that situation, a similar logic as that for FIG. 5 applies. If the stations failed to start a direct link SP during the OCWT, then they are expected to be awake on the base channel for the duration of the BCWT. During the BCWT time, either station may trigger a service period on the base channel.

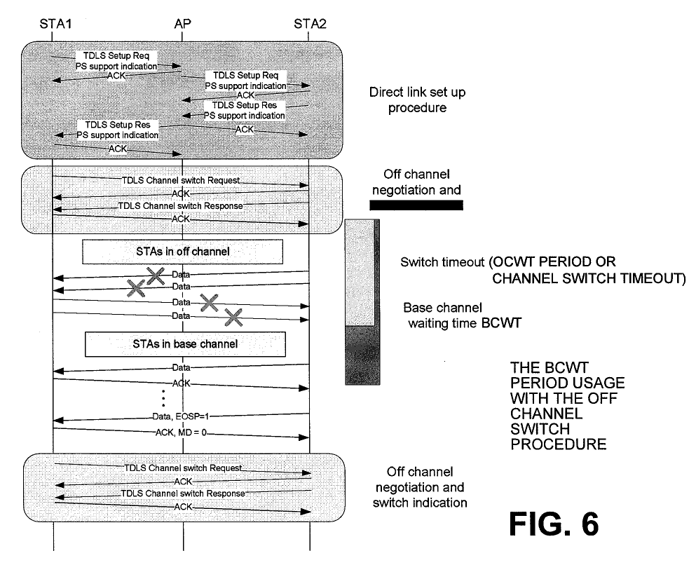

FIG. 6 is an example signaling diagram of the off channel switch procedure, that applies signaling that consists of two frames exchange to switch the channel. The channel switch signaling consists of channel switch request and channel switch response. After the channel switch response is transmitted the devices transit to off channel and wait for successful frame transmission for OCWT duration or channel switch timeout. If there is no successful frame transmission within OCWT period or channel switch timeout, the STA switch to base channel and stay available for the BCWT period.

At least one embodiment of the present invention provides the following exemplary advantages:
transmission of only a single packet is required with a corresponding acknowledgement when a channel is to be changed;
a fallback mechanism to the base channel is provided in case of unsuccessful channel switch.

However, it should be noted that certain embodiments of the present invention do not necessarily provide all or any of the exemplary advantages identified above.

An example embodiment of the invention is an apparatus, comprising:

means for transmitting by a first wireless device, a channel switch configuration request to a second wireless device to switch TDLS direct link from a base channel to an off channel, the request including PHY parameters for off channel, off channel waiting period during which at least one message is exchanged successfully between the first and second devices over the off channel; and

means for including a base channel waiting period in said channel switch request, during which the first and second devices should stay awake at the base channel in the event of their unsuccessful communication over the off channel.

An example embodiment of the invention is an apparatus, comprising:

means for receiving at a wireless device, a channel switch configuration request from another wireless device, to switch from a base channel to an off channel, the request including an off channel waiting period during which at least one message is exchanged successfully between the devices over the off channel; and

means for including a base channel waiting period in said channel switch request, during which the devices should stay awake at the base channel in the event of their unsuccessful communication over the off channel.

The apparatus may further include means for transmitting a channel switch configuration response in response to the request.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than Wireless LAN networks.

What is claimed is:

1. A method, comprising:
transmitting by a first wireless device, a channel switch request to a second wireless device to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

2. The method of claim 1, further comprising:
starting, by the first wireless device, a first timer measuring the off channel waiting period; and
starting, by the first wireless device, a second timer measuring the base channel waiting period.

3. The method of claim 1, further comprising:
continuing to operate in the base channel if a message is not successfully exchanged over the off channel within the off channel waiting period.

4. The method of claim 1, further comprising:
continuing operation in the off channel if at least one message is exchanged successfully between the first and second devices over the off channel until a channel switch indication is successfully exchanged.

5. The method of claim 1, wherein values of the off channel waiting period and the base channel waiting period are included in the transmitted channel switch request.

6. A device, comprising:
a transceiver; and
a processor configured to control the operation of the transceiver to:
transmit a channel switch request to a second wireless device to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

7. The device of claim 6, further comprising:
the processor further configured to control the operation of the transceiver to:
start a first timer measuring the off channel waiting period; and
start a second timer measuring the base channel waiting period.

8. The device of claim 6, further comprising:
the processor further configured to control the operation of the transceiver to:
continue to operate in the base channel if a message is not successfully exchanged over the off channel within the off channel waiting period.

9. The device of claim 6, further comprising:
the processor further configured to control the operation of the transceiver to:
continue operation in the off channel if at least one message is exchanged successfully between the first and second devices over the off channel until a channel switch indication is successfully exchanged.

10. The device of claim 6, wherein values of the off channel waiting period and the base channel waiting period are included in the transmitted channel switch request.

11. A computer readable medium, comprising:
a computer readable medium configured to store program instructions, which when executed by a computer processor, perform the steps of:
transmitting by a first wireless device, a channel switch request to a second wireless device to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

12. The computer readable medium of claim 11, further comprising:
program instructions, which when executed by a computer processor, perform the steps of:
starting, by the first wireless device, a first timer measuring the off channel waiting period; and
starting, by the first wireless device, a second timer measuring the base channel waiting period.

13. The computer readable medium of claim 11, further comprising:
program instructions, which when executed by a computer processor, perform the steps of:
continuing to operate in the base channel if a message is not successfully exchanged over the off channel within the off channel waiting period.

14. The computer readable medium of claim 11, further comprising:
program instructions, which when executed by a computer processor, perform the steps of:
continuing operation in the off channel if at least one message is exchanged successfully between the first and second devices over the off channel until a channel switch indication is successfully exchanged.

15. A method, comprising:
receiving at a wireless device, a channel switch request from another wireless device, to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

16. The method of claim 15, further comprising:
transmitting an acknowledgement back to the another wireless device in response to receiving the channel switch request;
starting a first timer measuring the off channel waiting period; and
starting a second timer measuring the base channel waiting period.

17. The method of claim 15, further comprising:
continuing to operate in the base channel if a message is not successfully exchanged over the off channel within the off channel waiting period.

18. The method of claim 15, further comprising:
continuing operation from the base channel to the off channel if at least one message is exchanged successfully between the devices over the off channel until a channel switch indication is successfully exchanged.

19. A device, comprising:
a transceiver; and
a processor configured to control the operation of the transceiver to:
receive at a wireless device, a channel switch request from another wireless device, to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

20. The device of claim 19, further comprising:
the processor further configured to control the operation of the transceiver to:
transmit an acknowledgement back to the another wireless device in response to receiving the channel switch request;
start a first timer measuring the off channel waiting period; and
start a second timer measuring the base channel waiting period.

21. The device of claim 19, further comprising:
the processor further configured to control the operation of the transceiver to:
continue to operate in the base channel if a message is not successfully exchanged over the off channel within the off channel waiting period.

22. The device of claim 19, further comprising:
the processor further configured to control the operation of the transceiver to:
continuing operation from the base channel to the off channel if at least one message is exchanged successfully between the devices over the off channel until a channel switch indication is successfully exchanged.

23. A computer readable medium, comprising:
a computer readable medium configured to store program instructions, which when executed by a computer processor, perform the steps of:
receiving at a wireless device, a channel switch request from another wireless device, to switch from a base channel to an off channel, the request relating to an off channel waiting period during which at least one message is expected to be exchanged successfully between the first and second devices over the off channel to initiate off channel communication;
wherein said channel switch request further relates to a base channel waiting period during which the first and second devices should stay awake at the base channel in the event of unsuccessful communication initiation over the off channel.

24. The computer readable medium of claim 23, further comprising:
program instructions, which when executed by a computer processor, perform the steps of:
transmitting an acknowledgement back to the another wireless device in response to receiving the channel switch request;
starting a first timer measuring the off channel waiting period; and
starting a second timer measuring the base channel waiting period.

25. The computer readable medium of claim 23, further comprising:
program instructions, which when executed by a computer processor, perform the steps of:
continuing to operate in the base channel if a message is not successfully exchanged over the off channel within the off channel waiting period.

26. The computer readable medium of claim 23, further comprising:
program instructions, which when executed by a computer processor, perform the steps of:
continuing operation from the base channel to the off channel if at least one message is exchanged successfully between the devices over the off channel until a channel switch indication is successfully exchanged.
